(19) United States
(12) Patent Application Publication
(10) Pub. No.: US 2019/0066158 A1
(43) Pub. Date: Feb. 28, 2019

(54) METHOD AND ELECTRONIC DEVICE FOR PROVIDING ADVERTISEMENT

(71) Applicant: SAMSUNG ELECTRONICS CO., LTD., Suwon-si (JP)

(72) Inventors: Hyun-soo CHOI, Seoul (KR); Ji-woong CHOI, Seoul (KR); Kyung-su KIM, Seoul (KR); Min-soo KIM, Yongin-si (KR); Sung-jin KIM, Yongin-si (KR); Il-koo KIM, Seongnam-si (KR); Chang-yeong KIM, Seoul (KR); Gun-hee LEE, Anyang-si (KR); Byung-joon CHANG, Seoul (KR); Won-young JANG, Anyang-si (KR); Ju-hee KIM, Suwon-si (KR); Joon-hyun LEE, Seoul (KR)

(21) Appl. No.: 16/019,966

(22) Filed: Jun. 27, 2018

(30) Foreign Application Priority Data
Aug. 31, 2017 (KR) 10-2017-0111044

(51) Int. Cl. G06Q 30/02; G06K 9/66; G06K 9/00

(52) U.S. Cl. CPC G06Q 30/0264; H04N 21/4126; G06K 9/00624; G06K 9/66

(57) ABSTRACT

An artificial intelligence (AI) system and application thereof, where the AI system simulates functions (e.g., recognition and judgment of the human brain) by using a machine learning algorithm like deep learning. In particular, an AI system and a method of providing content based on applications thereof are provided. The method includes obtaining, by an electronic device, a plurality of images included in content; and determining a time point for displaying an advertisement reproduced in synchronization with the content, based on at least one of a type of the content, image characteristics of the plurality of images, and a viewing pattern of a user.

### CROSS-REFERENCE TO RELATED APPLICATION

This application is based on and claims priority under 35 U.S.C. § 119 to Korean Patent Application No. 10-2017-0111044, filed on Aug. 31, 2017, in the Korean Intellectual Property Office, the disclosure of which is incorporated by reference herein in its entirety.

### BACKGROUND

### 1. Field

The disclosure relates to a method of providing an advertisement, an electronic device for providing an advertisement, and a recording medium having recorded thereon a program for implementing the method of providing an advertisement.

### 2. Description of Related Art

An Artificial intelligence (AI) system is a computer system that implements human-level intelligence and, unlike existing rule-based smart systems, is a machine that self-learns, self-judges, and becomes smart. The recognition capability of an AI system becomes more accurate the AI system becomes capable of understanding user preferences more accurately as the AI system is used more frequently. Therefore, conventional rule-based systems are being replaced by deep learning-based AI systems.

AI technologies include machine learning (deep learning) and element technologies that utilize machine learning.

Machine learning is algorithm technology that autonomously categorizes and learns characteristics of input data, and element technology is technology that simulates functions of the human brain, such as recognition and judgment, by using a machine learning algorithm, such as deep learning, and includes technical fields, such as linguistic comprehension, visual comprehension, reasoning/prediction, knowledge representation, and motion control.

Various fields to which AI technologies are applied are as follows. Linguistic comprehension is technology for recognizing, applying, and processing human languages/characters and includes natural language processing, machine translation, dialogue systems, inquiry/response, and speech recognition/synthesis. Visual comprehension is technology for recognizing and processing objects like human vision and includes object recognition, object tracking, image search, human recognition, image comprehension, spatial comprehension, and image enhancement. Reasoning/prediction is a technique for logically reasoning and predicting by judging information and includes knowledge/probability-based reasoning, optimization prediction, preference-base planning, and recommendation. Knowledge representation is technology for automating human experience information into knowledge data, including knowledge building (data generation/categorization) and knowledge management (data utilization). Motion control is a technique for controlling autonomous driving of a vehicle and motion of a robot and includes movement control (navigation, collision, driving, etc.), an operation control (behavior control), etc.

### SUMMARY

Provided is a method of effectively providing an advertisement without necessarily interfering immersion of a user with respect to content by obtaining, by an electronic device, a plurality of images included in the content, determining a time point for displaying an advertisement reproduced in synchronization with the content, based on at least one of a type of the content, image characteristics of the plurality of images, and a viewing pattern of a user, and displaying the advertisement at the determined time point.

Additional aspects will be set forth in part in the description which follows and, in part, will be apparent from the description, or may be learned by practice of the presented embodiments.

In accordance with an aspect of the disclosure, a method of providing an advertisement, the method includes obtaining, by an electronic device, a plurality of images included in content; determining a time point for displaying an advertisement reproduced in synchronization with the content, based on at least one of a type of the content, image characteristics of the plurality of images, and a viewing pattern of a user for the content; and displaying the advertisement at the determined time point.

In accordance with another aspect of the disclosure, an electronic device providing an advertisement, the electronic device includes a memory configured to store one or more instructions; a display; and a processor (including processing circuitry) configured to execute the one or more instructions stored in the memory, wherein a time point for displaying an advertisement reproduced in synchronization with the content, is determined based on at least one of a type of the content, image characteristics of the plurality of images, and a viewing pattern of a user for the content, and the advertisement is displayed at the determined time point.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram showing a method by which an electronic device provides an advertisement according to an example embodiment;

FIG. 2 is a flowchart showing a method by which an electronic device according to an example embodiment provides an advertisement;

FIG. 3 is a flowchart of a method by which an electronic device according to an example embodiment determines whether to display an advertisement on the electronic device;

FIG. 4 is a diagram for describing a method by which an electronic device determines the type of content by using a first learning network model according to an example embodiment;

FIG. 5 is a diagram for describing a method by which an electronic device determines a time point or location for displaying an advertisement by using a second learning network model according to an example embodiment;

FIG. 6 is a diagram for describing a method by which an electronic device determines a time point for displaying an advertisement according to an example embodiment;

FIG. 7 is a diagram for describing a method by which an electronic device determines a location for displaying an advertisement according to an example embodiment;

FIG. 8 is a diagram for describing a method by which an electronic device displays an advertisement according to an example embodiment;

FIG. 9 is a diagram for describing a method by which an electronic device changes the image quality of an object related to an advertisement according to an example embodiment;

FIG. 10 is a diagram showing a method of displaying an advertisement on a user's second device according to an example embodiment;

FIG. 11 is a diagram showing a method by which an electronic device displays an advertisement on an image not included in content, according to an example embodiment;

FIG. 12 is a block diagram of an electronic device that provides an advertisement according to an example embodiment;

FIG. 13 is a diagram for describing a processor according to an example embodiment;

FIG. 14 is a block diagram of a data learner according to an example embodiment;

FIG. 15 is a block diagram of a data recognizer according to an example embodiment; and

FIG. 16 is a block diagram of an electronic device that provides an advertisement according to another example embodiment.

### DETAILED DESCRIPTION

The terms used in this specification will be briefly described, and the present disclosure will be described in detail.

With respect to the terms in the various embodiments of the present disclosure, the general terms which are currently and widely used are selected in consideration of functions of structural elements in the various embodiments of the present disclosure. However, meanings of the terms may be changed according to intention, a judicial precedent, appearance of a new technology, and the like. In addition, in certain cases, a term which is not commonly used may be selected. In such a case, the meaning of the term will be described in detail at the corresponding part in the description of the present disclosure. Therefore, the terms used in the various embodiments of the present disclosure should be defined based on the meanings of the terms and the descriptions provided herein.

Terms including ordinal numbers such as first, second, etc. may be used to describe various elements, but the elements are not limited by terms. Terms are used only for the purpose of distinguishing one component from another. For example, without departing from the scope of the present disclosure, the first component may be referred to as a second component, and similarly, the second component may also be referred to as a first component. The term “and/or” includes any combination of a plurality of related items or any of a plurality of related items.

In addition, unless explicitly described to the contrary, the word “comprise” and variations such as “comprises” or “comprising” will be understood to imply the inclusion of stated elements but not the exclusion of any other elements. In addition, the term “units” described in the specification mean units for processing at least one function and operation and can be implemented by software components or hardware components, such as FPGA or ASIC. However, the “units” are not limited to software components or hardware components. The “units” may be embodied on a recording medium and may be configured to operate one or more processors. Therefore, for example, the “units” may include components, such as software components, object-oriented software components, class components, and task components, processes, functions, properties, procedures, subroutines, program code segments, drivers, firmware, micro codes, circuits, data, databases, data structures, tables, arrays, and variables. Components and functions provided in the “units” may be combined to smaller numbers of components and “units” or may be further divided into larger numbers of components and “units.”

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Therefore, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

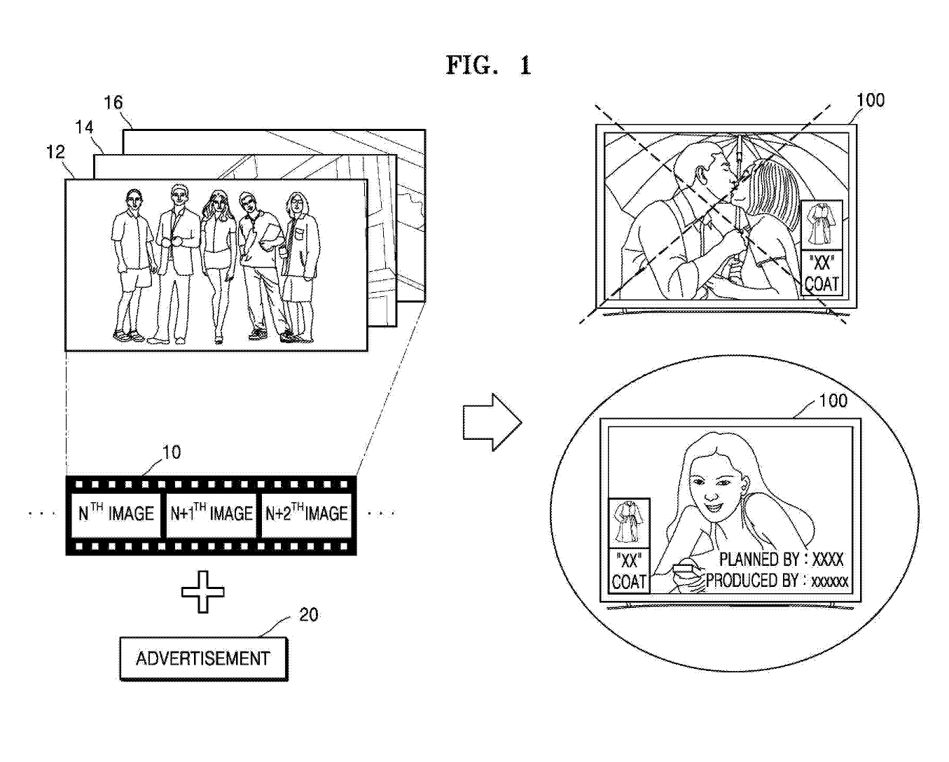

FIG. 1 is a schematic diagram showing a method by which an electronic device 100 provides an advertisement according to an example embodiment.

Referring to FIG. 1, the electronic device 100 may obtain content 10 that includes a plurality of images 12, 14, and 16. The content 10 according to an example embodiment may include multimedia related to a drama, a movie, a game, entertainment, sports, news, and comics, for example. An image included in the content 10 represents a part of the content 10 displayed screen-by-screen and may be used as a synonym for a still image, a picture, a frame, a scene, etc.

Furthermore, the electronic device 100 may obtain an advertisement 20. According to an example embodiment, the electronic device 100 may obtain the advertisement 20 associated with the content 10, to reproduce the advertisement 20 together with the content 10. The advertisement 20 may be provided as at least one of audio data, text data, and image data.

When the electronic device 100 according to an example embodiment reproduces the content 10, the electronic device 100 may display the advertisement 20 in synchronization with the content 10 based on an immersion level of a user of the electronic device 100 with respect to the content 10. For example, when the immersion level of the user exceeds a critical value, the electronic device 100 may not display the advertisement 20 during reproduction of the content 10 to prevent or reduce reduction of the immersion level of the user with respect to the content 10. For example, when the type of the content 10 is a movie, the immersion level of the user is high, and thus the electronic device 100 may not display the advertisement 20 while the drama is being reproduced. In another example, when the immersion level of the user does not exceed a critical value, in order to effectively provide the advertisement 20, the electronic device 100 may display the advertisement 20 in synchronization with the content 10 while the content 10 is being reproduced.

Furthermore, the electronic device 100 may determine a time point and a location for displaying the advertisement 20 in the case of displaying the advertisement 20 in synchronization with the content 10. For example, when the type of the content 10 is entertainment, the immersion level of the user is low, and thus the electronic device 100 may display the advertisement 20 at a time point at which an object related to the advertisement 20 appears. In another example, when the type of the content 10 is a drama, the immersion level of the user is high, and thus the electronic device 100 may display the advertisement 20 at the ending scene of the drama. Furthermore, the electronic device 100 may not display the advertisement 20 during the climax of the drama. The electronic device 100 may determine a location for displaying the advertisement 20 at a time point for displaying the advertisement 20. For example, with respect to a portion of the content 10 that is reproduced at a time point for displaying the advertisement 20, the electronic device 100 may determine a location for displaying the advertisement 20 to prevent or reduce an object included in the portion of the content 10 from being covered by the advertisement 20 as much as possible. The electronic device 100 may display the advertisement 20, such that the advertisement 20 is overlaid on the content 10 at a time point and a location for displaying the advertisement 20.

According to an example embodiment, electronic device 100 may be a smart TV, a smart phone, a tablet PC, a PC, a mobile phone, a personal digital assistant (PDA), a laptop, a media player, a micro server, an e-book device, a digital broadcasting device, a kiosk, an MP3 player, a digital camera, a consumer electronic device, and another mobile or non-mobile computing device, but is not limited thereto. Furthermore, the electronic device 100 may be a wearable device having a communication function and a data processing function, such as a wristwatch, an eyeglass, a hair-band, and a ring.

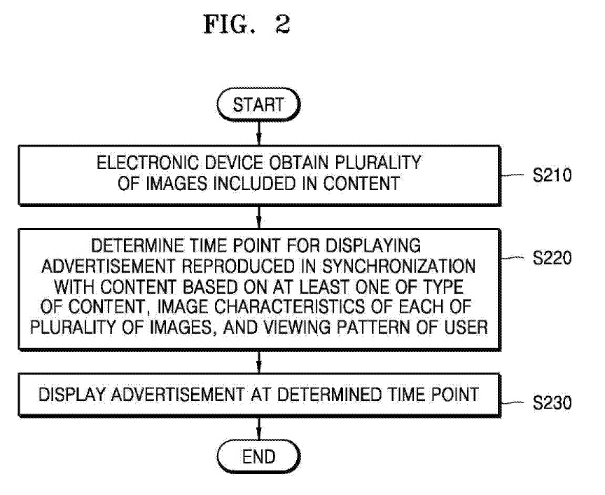

FIG. 2 is a flowchart showing a method by which an electronic device according to an example embodiment provides an advertisement.

In operation S210, the electronic device may obtain a plurality of images included in content.

According to an example embodiment, the electronic device may obtain a plurality of images included in content stored in the electronic device. For example, the electronic device may execute a video playback application or the like to obtain a plurality of images included in content already stored in the electronic device.

In another example embodiment, the electronic device may receive an image from a server. Here, the server may include at least one of a social network server, a cloud server, a web server, and a content-providing server. For example, when at least one of a web application, a browsing application, and a social network service (SNS) application is executed on the electronic device, the electronic device may access a server that supports the application being executed and obtain a plurality of images included in content. In another example embodiment, the electronic device may receive an image from another electronic device.

According to an example embodiment, the electronic device may obtain an advertisement from itself, another electronic device, and/or a server. The advertisement obtained by the electronic device may be an advertisement related to the content obtained by the electronic device. For example, the electronic device may obtain an advertisement corresponding to an object included in the content.

In operation S220, the electronic device may determine a time point for reproducing the advertisement in synchronization with the content based on at least one of the type of content, the image characteristics of each of a plurality of images included in the content, and a viewing pattern of a user.

According to an example embodiment, the electronic device may determine the type of the content based on additional information of the content obtained with the content. The additional information of the content may include information, such as a type of content, a reproduction time, an object included in the content, and the number of times that the content is viewed. Information regarding an object included in the content may include information regarding the type of the object (e.g., a person, an animal, a plant, etc.), information regarding importance of the object (e.g., a leading actor, a supporting actor, a popular star, etc.), and information regarding the object in relation to an advertisement. The type of the content may be a drama, a movie, a game, entertainment, sports, news, and comics. For example, the electronic device 100 may determine the type of content according to information on the type of the content included in additional information of the content.

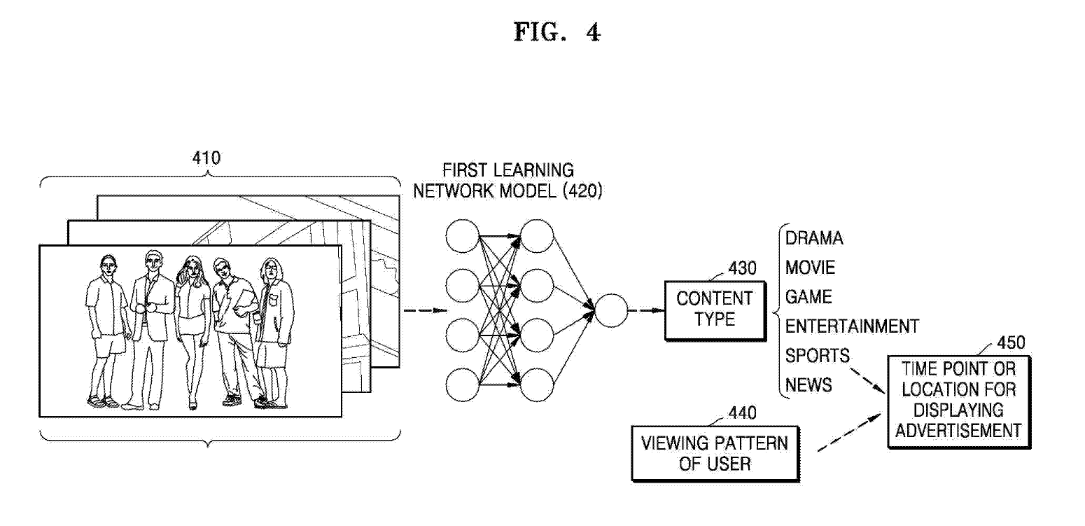

According to an example embodiment, an electronic device may determine the type of content using a first learning network model. The first learning network model may be an algorithm set for determining the type of content by extracting and using various characteristics from a plurality of images included in the content, based on a result of statistical machine learning. Furthermore, the first learning network model may be implemented as software or an engine for executing the algorithm set described above. The first learning network model implemented as software or an engine may be executed by a processor in the electronic device or a processor in a server. The first learning network model will be described below in more detail with reference to FIG. 4.

According to an example embodiment, the electronic device may determine a time point for displaying an advertisement based on at least one of a determined type of content, image characteristics of each of a plurality of images included in the content, and a viewing pattern of a user. For example, the electronic device may determine an immersion level of a user based on the type of content and a viewing pattern of the user. A viewing pattern of a user may include a viewing frequency of the user with respect to certain content, the number of channel changes made while the user is viewing the certain content, and feedback of the user regarding an advertisement reproduced in synchronization with the content (e.g., viewing details of the advertisement, termination of displaying of the advertisement, etc.). An immersion level of a user may be determined with respect to each of types of content, sub-types of content, or contents. For example, the sub-type of content may be a morning drama, an evening drama, a weekend drama, a historical drama, a romance drama, a mystery drama, a criminal investigation drama, or a fantasy drama, but is not limited thereto. According to an example embodiment, the electronic device may have preset immersion levels set for respective types of content. For example, high immersion levels may have been set for a drama, a movie, and entertainment, whereas low immersion levels may have been set for entertainment, sports, and news. As a user later watches content on the electronic device, the electronic device may change the immersion levels by learning a viewing pattern of the user. For example, when a user watches entertainment content at a high frequency, watches drama content at a normal frequency, and frequently changes channels while the user is watching drama content, the electronic device may increase an immersion level for entertainment content and reduce an immersion level for drama content. Furthermore, when the electronic device frequently receives user inputs for selecting an advertisement to be reproduced in synchronization with a morning drama while the user is watching the morning drama, the electronic device may reduce an immersion level for the morning drama to be lower than that for an evening drama. Furthermore, when the user watched every episode of a ‘CC drama’ without missing an episode, watched a ‘DD drama’ from episode 11, and changed channels while the user was watching the ‘DD drama,’ the electronic device may increase an immersion level for the ‘CC drama’ and reduce an immersion level for the ‘DD drama.’ According to an example embodiment, the electronic device may determine a time point for displaying an advertisement based on an immersion level of a user and image characteristics of each of a plurality of images.

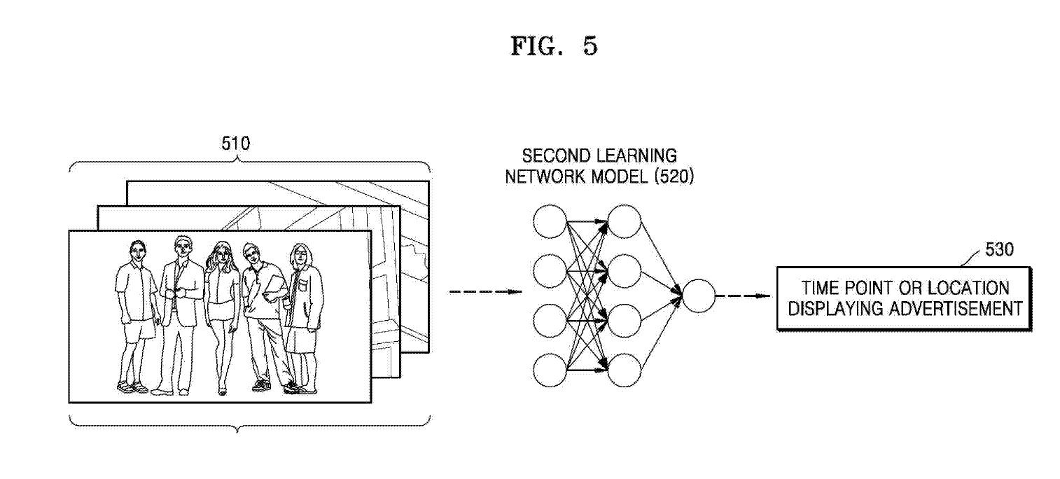

According to another example embodiment, the electronic device may determine a time point for displaying an advertisement by using a second learning network model. The second learning network model may be an algorithm set for determining the type of content by extracting and using various characteristics from a plurality of images included in the content, based on a result of statistical machine learning. Furthermore, the second learning network model may be implemented as software or an engine for executing the algorithm set described above. The second learning network model implemented as software or an engine may be executed by a processor in the electronic device or a processor in a server. The second learning network model will be described below in more detail with reference to FIG. 5.

According to an example embodiment, the electronic device may recognize a plurality of objects included in content based on image characteristics of each of a plurality of images. Here, the image characteristics may include colors, edges, polygons, saturation, brightness, color temperature, blur, sharpness, and contrast, but are not limited thereto.

The electronic device may recognize sound included in content. Sound included in content may include audio data of an object included in the content, music data included in the content (e.g., a theme song of each object, an ending song of each object, etc.), etc. The electronic device may determine a time point for displaying an advertisement based on plurality of recognized objects and recognized sounds.

According to an example embodiment, the electronic device may recognize an object associated with an advertisement based on image characteristics. An object associated with an advertisement may be an object including product placement information. The electronic device may determine an image including an object associated with a recognized advertisement from among a plurality of images included in content.

In operation S230, the electronic device may display an advertisement at a determined time point.

According to an example embodiment, the electronic device may reproduce content and an advertisement together at a determined time point. Therefore, at least one image included in the content and the advertisement may be reproduced in synchronization with each other. For example, when the advertisement includes a product image of an object included in the content, the electronic device may display the product image in synchronization with at least one image included in the content at a time point at which the at least one image included in the content is reproduced.

According to an example embodiment, the electronic device may determine a location for displaying an advertisement at a determined time point and display the advertisement at the time point and the location. For example, when an image included in content to be reproduced at a determined time point includes a person, the electronic device may display an advertisement at a location a pre-set distance or apart from the person in the image including the person.

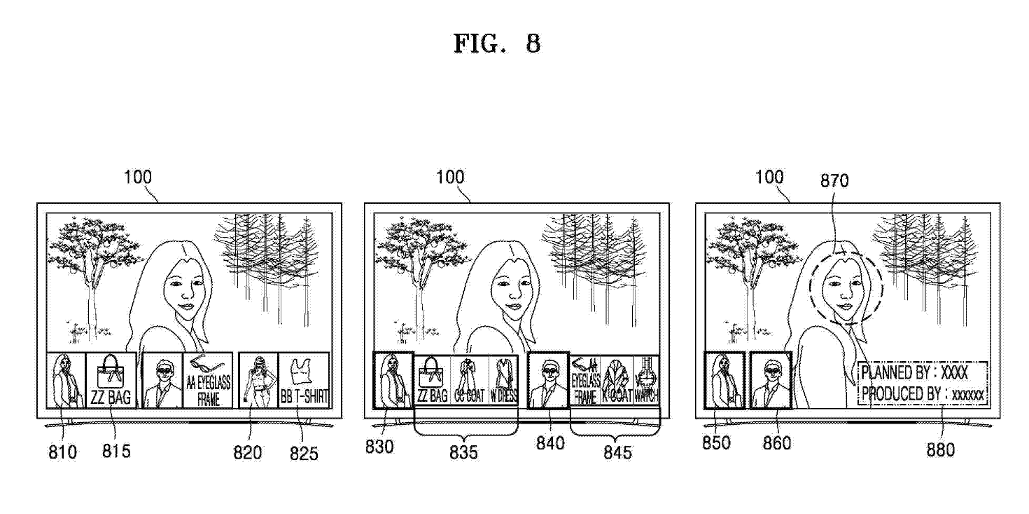

According to an example embodiment, the electronic device may display a plurality of advertisements corresponding to objects included in portions of content reproduced before a determined time point at the determined time point. Furthermore, the electronic device may display a plurality of advertisements respectively corresponding to a plurality of objects included in content. Detailed description thereof will be given below with reference to FIG. 8.

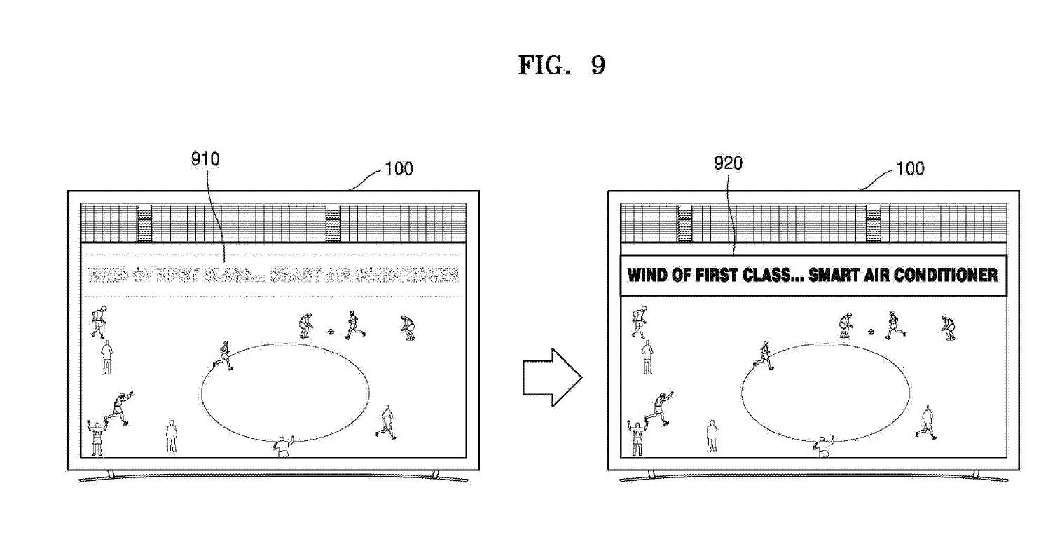

According to an example embodiment, the electronic device may change an image quality for an object associated with an advertisement. Detailed description thereof will be given below with reference to FIG. 9.

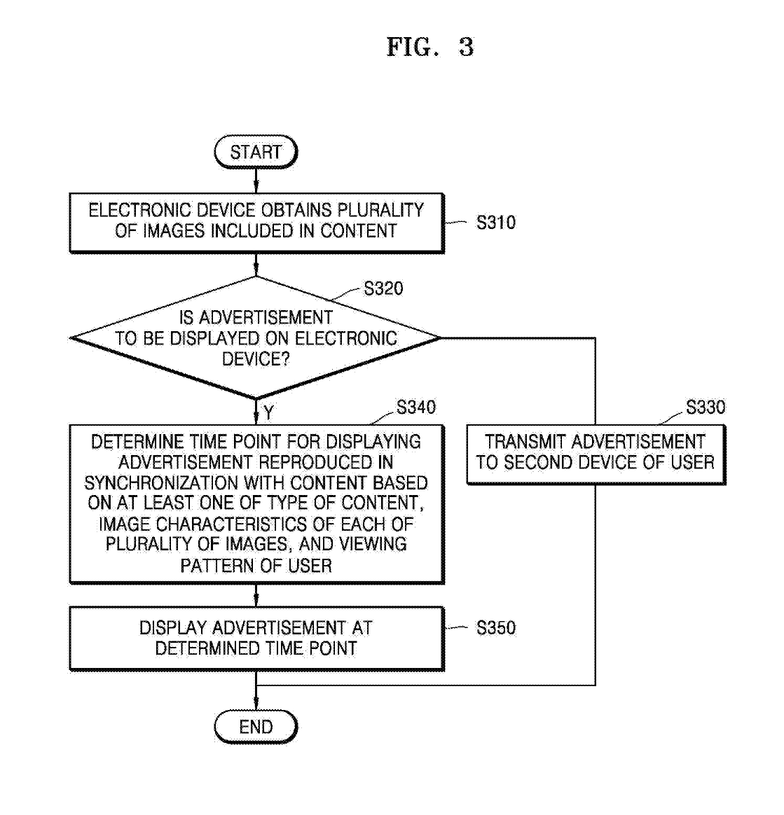

FIG. 3 is a flowchart of a method by which the electronic device 100 according to an example embodiment determines whether to display an advertisement on the electronic device 100.

In operation S310, the electronic device may obtain a plurality of images included in content.

Meanwhile, the operation S310 may correspond to operation S210 described above with reference to FIG. 2.

In operation S320, the electronic device may determine whether to display the advertisement on the electronic device.

According to an example embodiment, the electronic device may determine whether to display an advertisement on the electronic device based on the type of content and a viewing pattern of a user.

For example, the electronic device may determine an immersion level of the user based on the type of content and a viewing pattern of the user. The immersion level of the user may be pre-set according to the type of the content and may be customized based on the viewing pattern of the user. When the immersion level of the user is high, an advertisement is not to be displayed on the electronic device in order not to reduce the immersion level of the user. On the other hand, when the immersion level of the user is low, it is necessary to display an advertisement on the electronic device in synchronization with the content to effectively provide the advertisement. Therefore, the electronic device may determine whether to display the advertisement on the electronic device.

In operation S330, the electronic device may transmit the advertisement to a user's second device. According to an example embodiment, the electronic device may transmit an advertisement to the user's second device when the advertisement is not displayed on the electronic device. For example, when an immersion level of a user is high, instead of not displaying an advertisement on the electronic device so as not to reduce the immersion level, the electronic device may transmit the advertisement to the user's second device. The user's second device may only display the advertisement without synchronizing with the content.

According to another example embodiment, the electronic device may transmit an advertisement to the user's second device, even when the advertisement is displayed on the electronic device. For example, when an advertisement is requested by the user's second device, the electronic device may transmit the advertisement to the user's second device. Furthermore, for example, when it is determined that it is necessary to display an advertisement on the user's second device (e.g., when the electronic device receives a user input for selecting an advertisement displayed on the electronic device), the electronic device may transmit the advertisement to the user's second device.

In operation S340, the electronic device may determine a time point for displaying an advertisement to be reproduced in synchronization with content, based on at least one of the type of content, image characteristics of each of a plurality of images included in the content, and a viewing pattern of the user.

Meanwhile, operation S340 may correspond to operation S220 described above with reference to FIG. 2.

In operation S350, the electronic device may display an advertisement at a determined time point.

Meanwhile, operation S350 may correspond to operation S230 described above with reference to FIG. 2.

FIG. 4 is a diagram for describing a method by which the electronic device 100 determines the type of content by using a first learning network model according to an example embodiment.

Referring to FIG. 4, the electronic device 100 may utilize a plurality of images 410 included in content as input data for a first learning network model 420. Here, the first learning network model 420 may be generated as a result of training criteria for determining a content type 430 based on the plurality of images 410. In this case, the first learning network model 420 may be a model generated in advance. For example, the first learning network model 420 may be a model generated in advance in order to receive basic learning data (e.g., sample images) and output the content type 430.

The electronic device 100 may determine a time point or location 450 for displaying an advertisement based on at least one of the content type 430, image characteristics of each of the plurality of images 410, and a user's viewing pattern 440. For example, the electronic device 100 may determine only a time point for displaying an advertisement, may determine only a location for displaying an advertisement, or may determine both a time point and a location for displaying an advertisement.

Meanwhile, although an example in which the plurality of images 410 included in the content are utilized as input data for the first learning network model 420 is described above with reference to FIG. 4, it is merely an embodiment, and sound included in the content may also be utilized as input data. For example, sound, such as a song or a voice set to be reproduced when at least one image of the content is reproduced, may also be utilized as input data for the first learning network model 420.

FIG. 5 is a diagram for describing a method by which the electronic device 100 determines a time point or location for displaying an advertisement by using a second learning network model according to an example embodiment.

Referring to FIG. 5, the electronic device 100 may apply a plurality of images 510 included in content as input data for a second learning network model 520. Here, the second learning network model 520 may be generated as a result of training criteria for determining a time point or location 530 for displaying an advertisement based on the plurality of images 510. In this case, the second learning network model 520 may be a model generated in advance. For example, the second learning network model 520 may be a model generated in advance in order to receive basic learning data (e.g., sample images) and output a time point or location 530 for displaying an advertisement.

The electronic device 100 may obtain the time point or location 530 for displaying an advertisement output as a result of inputting the plurality of images 510. For example, the electronic device 100 may output only a time point for displaying an advertisement, may output only a location for displaying an advertisement, or may output both a time point and a location for displaying an advertisement.

Meanwhile, although an example in which the plurality of images 510 included in the content are utilized as input data for the second learning network model 520 is described above with reference to FIG. 5, it is merely an embodiment, and sound included in the content may also be utilized as input data. For example, sound, such as a song or a voice set to be reproduced when at least one image of the content is reproduced, may also be utilized as input data for the second learning network model 520.

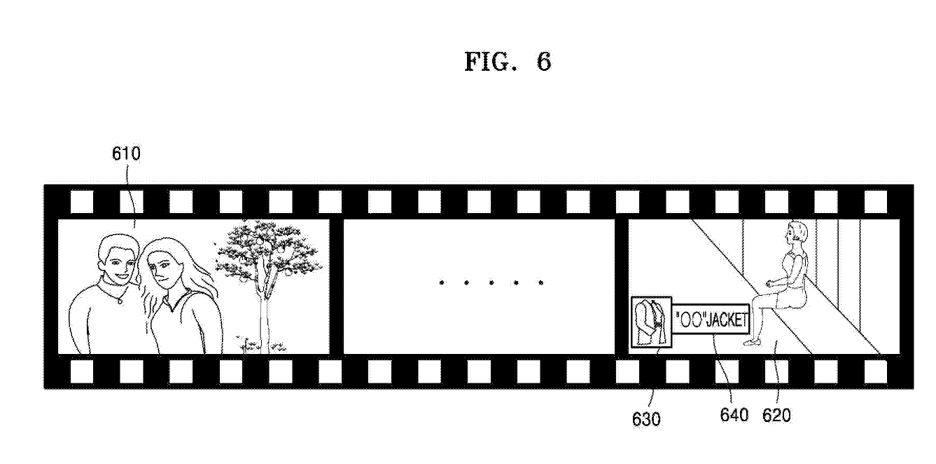

FIG. 6 is a diagram for describing a method by which the electronic device 100 determines a time point for displaying an advertisement according to an example embodiment.

According to an example embodiment, the electronic device 100 may recognize a plurality of objects included in content based on image characteristics of a plurality of images included in the content. For example, the electronic device 100 may also recognize the importance of objects based on the image characteristics and additional information of the content. According to an example embodiment, the electronic device 100 may recognize sound included in the content. For example, the electronic device 100 may recognize voice data of an object included in the content, music data included in the content (e.g., a theme song of each object, an ending song of each object, etc.), etc.

According to an example embodiment, the electronic device 100 may determine a time point for displaying an advertisement based on plurality of recognized objects and recognized sounds. For example, when the electronic device 100 recognizes that an image 610 included in content includes a female leading actress and a young male artist and a theme song of the young male artist is being played, the electronic device 100 may display an advertisement a certain time after the image 610 is displayed so as not to disturb immersion of a user. For example, the electronic device 100 may determine a time point at which an image 620 including a supporting actor is displayed as a time point for displaying an advertisement. The electronic device 100 may display an image 630 of a jacket worn by the young male artist before the time point for displaying an advertisement and a text 640 describing an advertised product at the time point for displaying an advertisement.

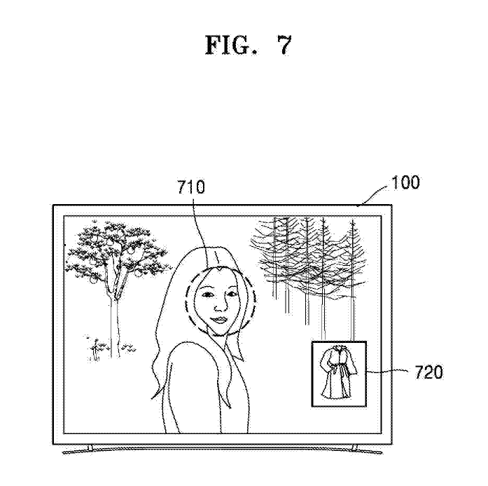

FIG. 7 is a diagram for describing a method by which the electronic device 100 determines a location for displaying an advertisement according to an example embodiment.

According to an example embodiment, the electronic device 100 may determine a location for displaying an advertisement 720 at a time point for displaying the advertisement 720 and may display the advertisement 720 at the determined time point and the determined location.

According to an example embodiment, the electronic device 100 may compare information regarding colors and polygons obtained from a plurality of images to existing information regarding colors and polygons of a plurality of objects, thereby recognizing objects included in each of the plurality of images. In another example embodiment, the electronic device 100 may recognize objects included in each of the plurality of images by applying each of the plurality of images as input data for a learning network model that learned characteristics of various types of objects. For example, the electronic device 100 may recognize whether a person is included in an image included in content and being reproduced at a time point for displaying the advertisement 720. Furthermore, the electronic device 100 may recognize whether a face 710 of a person is included in an image included in the content and being reproduced at the time point for displaying the advertisement 720.

According to an example embodiment, the electronic device 100 may obtain information regarding a location of at least one object in each of a plurality of images included in content. Information regarding a location of at least one object may include information regarding a coordinate of the at least one object on a two-dimensional plane, but the present disclosure is not limited thereto. In another example embodiment, information regarding a location of at least one object may include information regarding relative locations of a plurality of objects included in an image. For example, the electronic device 100 may obtain information regarding a location of at least one object, and thus the electronic device 100 may display the advertisement 720 at a location a pre-set distance apart from the face 710 of a person in an image including the face 710 of the person.

FIG. 8 is a diagram for describing a method by which the electronic device 100 displays an advertisement according to an example embodiment.

As shown in FIG. 8, the electronic device 100 may display a plurality of advertisements corresponding to objects included in content reproduced before a time point for displaying an advertisement at the time point for displaying an advertisement. According to an example embodiment, the electronic device 100 may determine that the type of content is a drama and a time point for displaying an advertisement is the ending scene of the drama based on at least one of reproduction time of the drama included in additional information of the content, a recognized ending song of the drama, a closed-up face 870 of a leading actor of the drama, and a subtitle 880 included in the ending scene of the drama. For example, when a plurality of advertised products are included in a scene reproduced before the time point for displaying an advertisement, the electronic device 100 may display advertisements corresponding to the plurality of advertised products at the time point for displaying an advertisement at once.

According to an example embodiment, the electronic device 100 may alternately display scenes including products advertised in content and advertisements. For example, when a scene 810 including a ZZ purse and a scene 820 including a BB T-shirt were reproduced before a time point for displaying an advertisement, the electronic device 100 may sequentially display the scene 810 including the ZZ purse, an advertisement 815 of the ZZ purse, the scene 820 including the BB T-shirt, and an advertisement 825 of the BB T-shirt.

According to another example embodiment, the electronic device 100 may display a plurality of advertisements corresponding to a plurality of objects included in content for each of the plurality of objects. For example, when content includes a female protagonist 830 and a male protagonist 840, advertisements 835 of products related to the female protagonist 830 and advertisements of products related to the male protagonist 840 may be grouped and displayed with respect to each of the female protagonist 830 and the male protagonist 840. For example, the female protagonist 830, the advertisements 835 of the products related to the female protagonist 830, the male protagonist 840, and advertisements 845 of the products related to the male protagonist 840 may be sequentially displayed. In another example embodiment, only the female protagonist 830 and the male protagonist 840 may be displayed and, when the electronic device 100 receives a user input for selecting the female protagonist 830, the advertisements of the products related to the female protagonist 830 may be displayed. Alternatively, when the electronic device 100 receives a user input for selecting the male protagonist 840, the advertisements 845 of the products related to the male protagonist 840 may be displayed.

FIG. 9 is a diagram for describing a method by which the electronic device 100 changes the image quality of an object related to an advertisement according to an example embodiment.

Referring to FIG. 9, the electronic device 100 may recognize an object 910 related to an advertisement included in content being reproduced on the electronic device 100 and change the image quality of the object 910 related to the advertisement.

According to an example embodiment, the electronic device 100 may capture a screen image of the electronic device 100 as content is executed. The electronic device 100 may recognize a plurality of objects included in the captured screen image based on image characteristics of the captured screen image. For example, the electronic device 100 may recognize that the captured screen image includes athletes, a ball, and an object 910 related to an advertisement showing the text “wind of first class . . . smart air conditioner.”

The electronic device 100 according to an example embodiment may change the image quality of an area in which the object 910 related to the advertisement is displayed. For example, based on that the type of content being reproduced on the electronic device 100 is sports and the object 910 related to the advertisement is a text for product placement, the electronic device 100 may obtain an object 920 related to the advertisement, bold the object 920 by increasing saturation and sharpness of the object 910 related to the advertisement, and display the object 920.

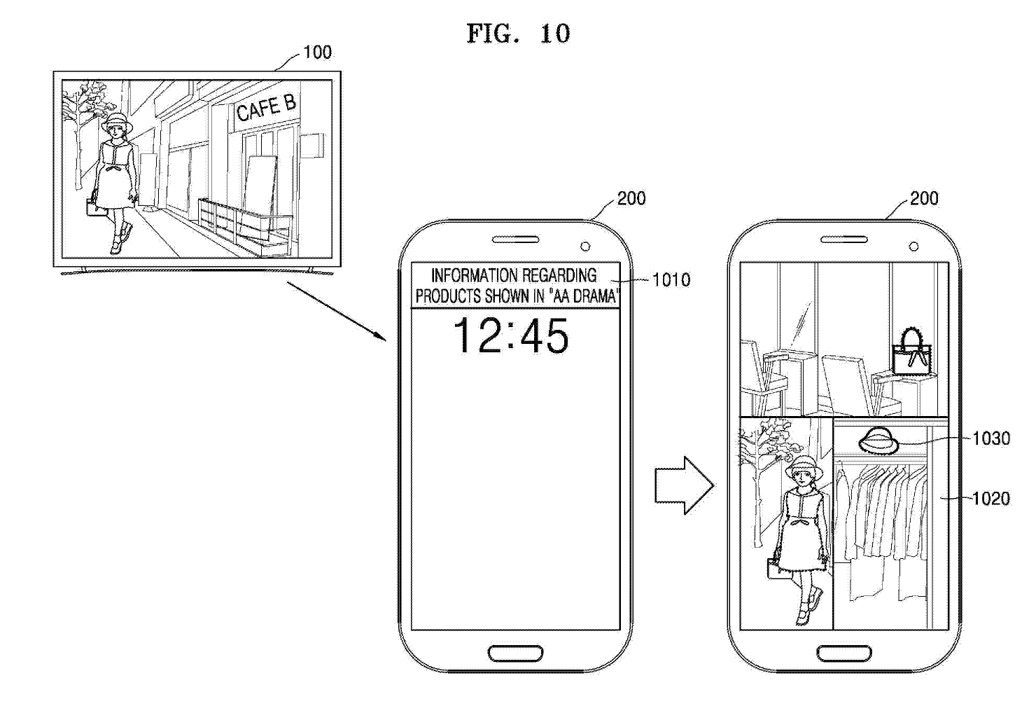

FIG. 10 is a diagram showing a method of displaying an advertisement on a user's second device 200 according to an example embodiment.

According to an example embodiment, the electronic device 100 may transmit an advertisement to the user's second device 200 when the advertisement is not displayed on the electronic device 100. For example, the electronic device 100 may be a smart TV, whereas the user's second device 200 may be a mobile phone.

According to an example embodiment, the user's second device 200 may receive an advertisement from the electronic device 100 during reproduction of an ‘AA drama’ on the electronic device 100. In response to the reception of the advertisement from the electronic device 100, the user's second device 200 may output a notification 1010 notifying that the advertisement is information regarding products shown in the ‘AA drama’ being reproduced on the electronic device 100. When the user's second device 200 receives a user input for selecting the notification 1010, the user's second device 200 may display a plurality of images including products shown in the ‘AA drama’. For example, the user's second device 200 may change the image quality of a hat 1030 shown in the AA drama to display an image 1020 including the hat 1030 shown in the AA drama.

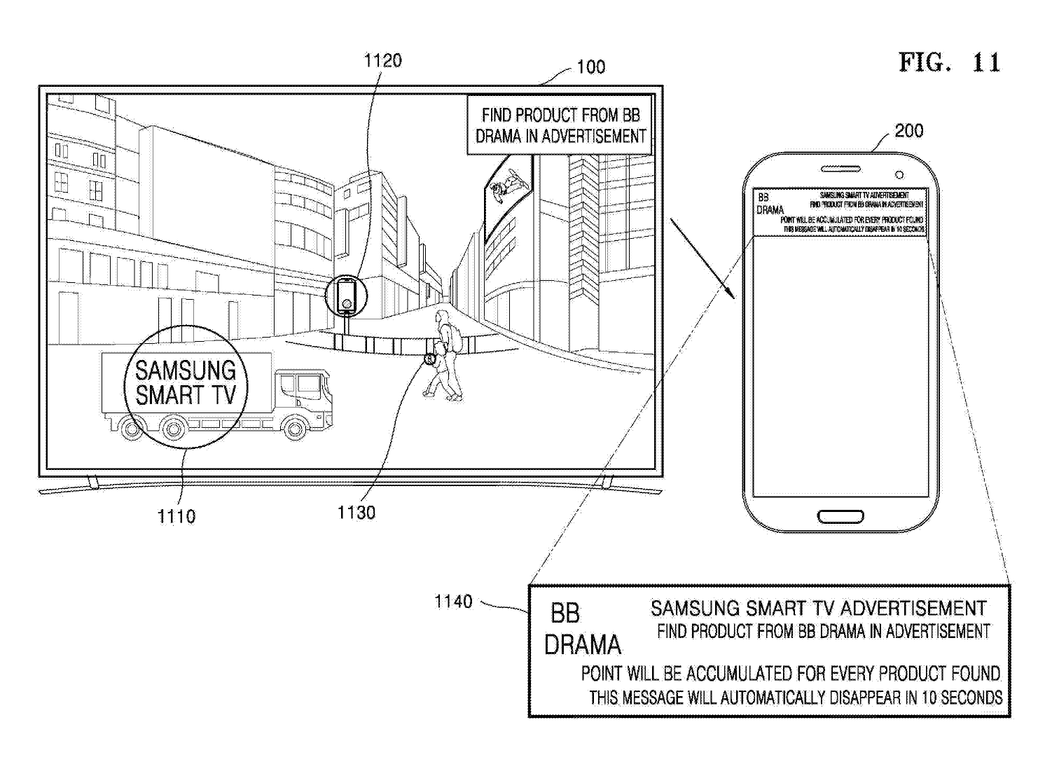

FIG. 11 is a diagram showing a method by which the electronic device 100 displays an advertisement on an image not included in content, according to an example embodiment.

According to an example embodiment, the electronic device 100 may display an advertisement related to content in synchronization with an image that is not included in the content and is reproduced after the reproduction of the content ends. For example, the electronic device 100 may overlay an image of a product shown in a BB drama on an image included in a smart TV advertisement that is reproduced after reproduction of the BB drama is finished. For example, the electronic device 100 may overlay a text 1110 of a smart TV shown in the BB drama on a truck and display an image 1130 of a beverage shown in the BB drama as when the child is holding the beverage. Furthermore, the electronic device 100 may overlay an image 1120 of a smart phone shown in the BB drama on a traffic light. As described above, the electronic device 100 may overlay an image of a product shown in the BB drama, such that there is no disruption in an image included in a smart TV advertisement reproduced after the BB drama is reproduced.

According to an example embodiment, the electronic device 100 may transmit an image obtained by overlaying an advertisement related to content on an image not included in the content to the user's second device 200. According to an example embodiment, as the user's second device 200 receives an image obtained by overlaying an advertisement related to content on an image not included in the content, the user's second device 200 may display a notification 1140 notifying “find products shown in BB drama in advertisement”. When the user's second device 200 receives a user input for selecting the notification 1010, the user's second device 200 may display an image obtained by overlaying an advertisement related to content on an image not included in the content. Furthermore, every time the user's second device 200 receives a user input for selecting an overlaid image of an advertisement related to content, the user's second device 200 may pay points similar to cash to a user.

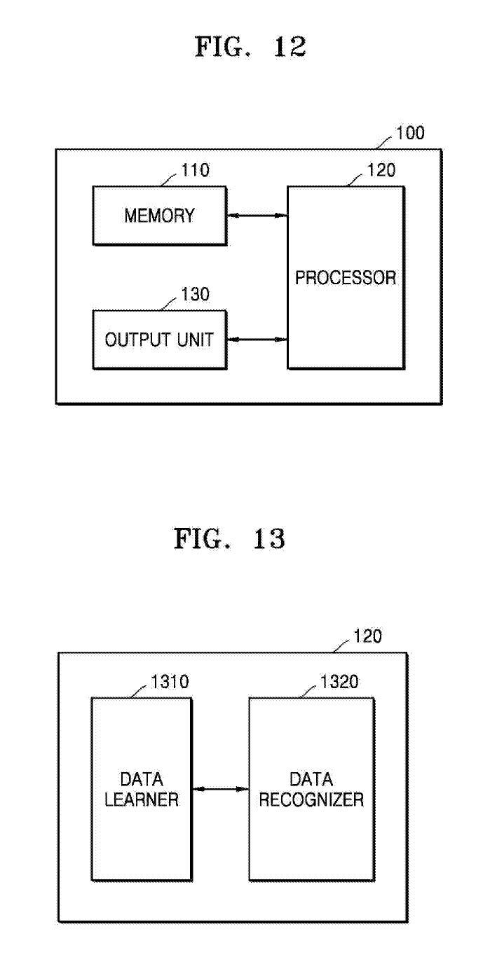

FIG. 12 is a block diagram of the electronic device 100 that provides an advertisement according to an example embodiment.

Referring to FIG. 12, an electronic device 100 may include a memory 110, a processor 120 (including processing circuitry), and a display 130.

The memory 110 may store programs (one or more instructions) for processing and controlling of the processor 120. Programs stored in the memory 110 may be categorized into a plurality of modules according to functions. According to an example embodiment, the memory 110 may include software modules including a data learner and a data recognizer. Detailed description thereof will be given below reference to FIG. 13. Furthermore, the data learner and the data recognizer may each independently include a learning network model or share a learning network model.

The processor 120 may include one or more cores (not shown), a graphics processor (not shown), and/or a connection path (e.g., a bus) for transmitting and receiving signals to and from other components.

According to an example embodiment, the processor 120 may perform the operations of the electronic device 100 described above with reference to FIGS. 1 through 11.

According to an example embodiment, the processor 120 may obtain a plurality of images included in content. The processor 120 may determine a time point for displaying an advertisement to be reproduced in synchronization with the content based on at least one of the type of the content, image characteristics of each of the plurality of images, and a viewing pattern of a user and display the advertisement at the determined time point.

For example, the processor 120 may determine the type of content based on a plurality of images included in the content by using a first learning network model.

In another example embodiment, the processor 120 may determine at least one of a time point for displaying an advertisement and a location for displaying the advertisement based on a plurality of images included in content by using a second learning network model.

The processor 120 according to an example embodiment may recognize a plurality of objects included in content based on image characteristics of the plurality of images included in the content and recognize sound included in the content. The processor 120 may determine a time point for displaying an advertisement based on the plurality of recognized objects and the recognized sound.

The processor 120 according to an example embodiment may recognize an object associated with an advertisement based on image characteristics of a plurality of images included in content. The processor 120 may determine an image including the recognized object from among the plurality of images included in the content and display an advertisement on the determined image. Furthermore, the processor 120 may determine whether the determined image includes a person. For example, the processor 120 may not display an advertisement on the determined image when the determined image includes a person. Alternatively, when the determined image includes a person, the processor 120 may display an advertisement at a location a certain distance or apart from the person in the determined image.

The processor 120 according to an example embodiment may change image quality for an object related to an advertisement.

The processor 120 according to an example embodiment may display a plurality of advertisements corresponding to objects included in content reproduced before a determined time point for displaying an advertisement at the determined time point.

The processor 120 according to an example embodiment may display a plurality of advertisements corresponding to a plurality of objects included in content for each of the plurality of objects.

The processor 120, according to an example embodiment, may determine whether to display an advertisement on an electronic device 100 based on the type of content and a viewing pattern of a user. For example, when an advertisement is not displayed on the electronic device, the processor 120 may control a communicator 1650 to transmit the advertisement to a user's second device. Alternatively, even when an advertisement is displayed on the electronic device, the processor 120 may control the communicator 1650 to transmit a advertisement to the user's second device even.

The processor 120 may include random access memory (RAM) (not shown) and read only memory (ROM) (not shown) for temporarily and/or permanently storing signals (or data) processed by the processor 120. Furthermore, the processor 120 may be implemented as a system-on-chip (SoC) including at least one of a graphics processor, RAM, and ROM.

The display 130 may display at least one image included in content. Furthermore, the display 130 may display an advertisement synchronized with the content.

FIG. 13 is a diagram for describing the processor 120 according to an example embodiment.

Referring to FIG. 13, the processor 120 according to an example embodiment may include a data learner 1310 and a data recognizer 1320.

The data learner 1310 may learn criteria for determining the type of content. Furthermore, according to another example embodiment, the data learner 1310 may learn criteria for determining at least one of a time point and a location for displaying an advertisement.

The data recognizer 1320 may determine the type of content or determine at least one of a time point and a location for displaying an advertisement based on criteria learned through the data learner 1310.

At least one of the data learner 1310 and the data recognizer 1320 may be fabricated as at least one hardware chip and mounted on an electronic device. For example, at least one of the data learner 1310 and the data recognizer 1320 may be fabricated as a dedicated hardware chip for artificial intelligence (AI) or may be fabricated as a portion of a conventional general-purpose processor (e.g., a CPU or an application processor) or a graphics processor (e.g., a GPU) and mounted on various electronic devices as described above.

In this case, the data learner 1310 and the data recognizer 1320 may be mounted on one electronic device or may be respectively mounted on separate electronic devices. For example, one of the data learner 1310 and the data recognizer 1320 may be included in an electronic device and the other one may be included in a server. The data learner 1310 and the data recognizer 1320 may be connected to each other via a wire or wirelessly. Therefore, model information generated by the data learner 1310 may be provided to the data recognizer 1320 or data input to the data recognizer 1320 may be provided to the data learner 1310 as additional learning data.

Meanwhile, at least one of the data learner 1310 and the data recognizer 1320 may be implemented as a software module. When at least one of the data learner 1310 and the data recognizer 1320 is implemented as a software module (or a program module including instructions), the software module may be stored in a non-transitory computer-readable recording medium. Furthermore, in this case, at least one software module may be provided by an operating system (OS) or by a certain application. Alternatively, some of the at least one software module may be provided by an OS, and the remaining of the at least one software module may be provided by a certain application.

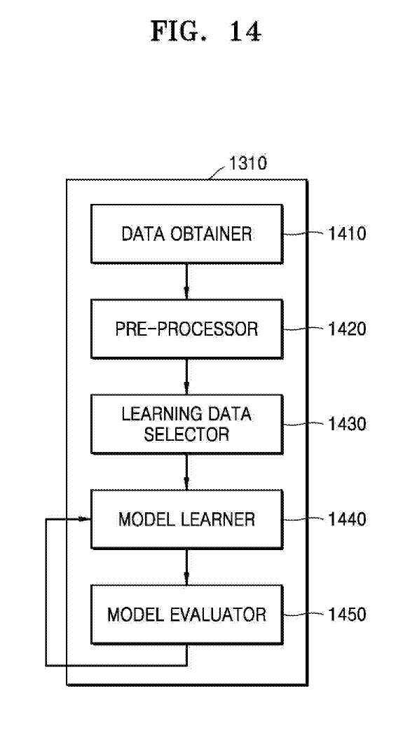

FIG. 14 is a block diagram of the data learner 1310 according to an example embodiment.

Referring to FIG. 14, the data learner 1310 according to some embodiments may include a data obtainer 1410, a pre-processor 1420 (including processing circuitry), a learning data selector 1430, a model learner 1440, and a model evaluator 1450. However, it is merely an embodiment, and the data learner 1310 may include components fewer than those described above or components other than the above-described components may be additionally included in the data learner 1310.

The data obtainer 1410 may obtain a plurality of images included in content as learning data. For example, the data obtainer 1410 may obtain a plurality of images from an electronic device including the data learner 1310 or an external electronic device capable of communicating with the electronic device including the data learner 1310.

Meanwhile, the plurality of images obtained by the data obtainer 1410 according to an example embodiment may include any one of a plurality of images included in content categorized according to types of content. For example, the data obtainer 1410 may obtain a plurality of images included in content categorized according to types of content, for learning.

The data obtainer 1410 may also obtain information regarding a viewing pattern of a user to learn criteria for determining at least one of a time point and a location for displaying an advertisement.

The pre-processor 1420 (including processing circuitry) may preprocess a plurality of obtained images, such that the plurality of obtained images may be used for learning for determination of the type of content or determination of at least one of a time point and a location of advertisement. The pre-processor 1420 may process the plurality of obtained images into a pre-set format, such that the model learner 1440, as described below, may use the plurality of obtained images for learning.

Furthermore, the pre-processor 1420 may preprocess obtained information regarding a viewing pattern of a user, such that the obtained information regarding the viewing pattern of the user may be used for learning for determining at least one of a time point and a location for displaying an advertisement.

The learning data selector 1430 may select an image for learning from preprocessed data. The selected image may be provided to the model learner 1440. The learning data selector 1430 may select an image for learning from among a plurality of pre-processed images according to set criteria.

The model learner 1440 may learn criteria regarding which of image characteristics are to be used for determining type of content or at least one of a time point and a location for displaying an advertisement, in a plurality of layers in a learning network model. For example, the model learner 1440 may learn criteria regarding extracted characteristic information from which of a plurality of layers included in a learning network model are to be used for determining the type of content. Here, the criteria regarding extracted characteristic information from which of a plurality of layers included in a learning network model are to be used may include types, numbers, or levels of images used by an electronic device to determine the type of content by using the learning network model.

According to an example embodiment, a model for receiving a plurality of images and outputting type of content may be a first learning network model, whereas a model for inputting a plurality of images and outputting at least one of a time point and a location for displaying an advertisement may be a second learning network model. Here, the first learning network model may be generated as a result of learning criteria for determining type of content based on a plurality of images. Furthermore, the second learning network model may be generated as a result of learning criteria for determining at least one of a time point and a location for displaying an advertisement based on a plurality of images and a viewing pattern of a user.

According to various embodiments, when there are a plurality of data recognition models generated in advance, the model learner 1440 may determine a data recognition model corresponding to basic learning data highly related to input learning data as a data recognition model to learn. In this case, basic learning data may be categorized in advance according to types of data, and a data recognition model may be generated in advance according to types of data. For example, basic learning data may be categorized in advance according to various criteria, such as areas where learning data is generated, times at which the learning data is generated, sizes of the learning data, genres of the learning data, creators of the learning data, and types of objects in the learning data.

Furthermore, the model learner 1440 may perform reinforced learning using feedback on whether at least one of the type of content or a time point and a location for displaying an advertisement determined based on learning is correct, thereby learning a data recognition model.

Furthermore, when a data recognition model is learned, the model learner 1440 may store the learned data recognition model. In this case, the model learner 1440 may store the learned data recognition model in a memory of an electronic device including the data recognizer 1320. Alternatively, the model learner 1440 may store the learned data recognition model in a memory of a server that is connected to an electronic device via a wire network or a wireless network.

In this case, a memory in which the learned data recognition model is stored may also store, for example, commands or data related to at least one of the other components of an electronic device. The memory may also store software and/or programs. The programs may include, for example, a kernel, middleware, an application programming interface (API), and/or an application program (or “application”).

The model evaluator 1450 inputs evaluation data to a data recognition model and, when a result of a recognition output based on the evaluation data does not satisfy a certain criteria, may make the model learner 1440 learn again. In this case, the evaluation data may be pre-set data for evaluating a data recognition model. Here, the evaluation data may include a consistency ratio between types of content identified based on a learning network model and actual types of the content. In another example embodiment, the evaluation data may include a consistency ratio between time points for displaying an advertisement determined based on a learning network model and actually suitable time points for displaying an advertisement. Furthermore, the evaluation data may include a consistency ratio between locations for displaying an advertisement determined based on a learning network model and actually suitable locations for displaying an advertisement.

On the other hand, when there are a plurality of learning network models, the model evaluator 1450 evaluates whether each learning network model satisfies certain criteria and determines a learning network model satisfying the certain criteria as a final learning network model.

At least one of the data obtainer 1410, the pre-processor 1420, the learning data selector 1430, the model learner 1440, and the model evaluator 1450 in the data learner 1310 may be fabricated as a hardware chip and mounted on an electronic device. For example, at least one of the data obtainer 1410, the pre-processor 1420, the learning data selector 1430, the model learner 1440, and the model evaluator 1450 may be fabricated as a dedicated hardware chip for artificial intelligence (AI) or may be fabricated as a portion of a conventional general-purpose processor (e.g., a CPU or an application processor) or a graphics processor (e.g., a GPU) and mounted on various electronic devices as described above.

Alternatively, the data obtainer 1410, the pre-processor 1420, the learning data selector 1430, the model learner 1440, and the model evaluator 1450 may be mounted on one electronic device or may be respectively mounted on separate electronic devices. For example, some of the data obtainer 1410, the pre-processor 1420, the learning data selector 1430, the model learner 1440, and the model evaluator 1450 may be included in an electronic device, and the other ones may be included in a server.

At least one of the data obtainer 1410, the pre-processor 1420, the learning data selector 1430, the model learner 1440, and the model evaluator 1450 may be implemented as a software module. When at least one of the data obtainer 1410, the pre-processor 1420, the learning data selector 1430, the model learner 1440, and the model evaluator 1450 is implemented as a software module (or a program module including instructions), the software module may be stored in a non-transitory computer-readable recording medium. Furthermore, in this case, at least one software module may be provided by an OS or by a certain application. Alternatively, some of the at least one software module may be provided by an OS, and the remaining of the at least one software module may be provided by a certain application.

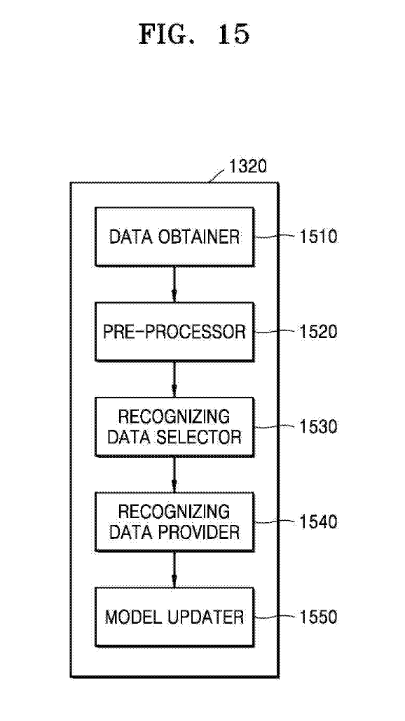

FIG. 15 is a block diagram of the data recognizer 1320 according to an example embodiment.

Referring to FIG. 15, the data recognizer 1320 according to some embodiments may include a data obtainer 1510, a pre-processor 1520 (including processing circuitry), a recognizing data selector 1530, a recognition result provider 1540, and a model modifying and refining unit 1550.

The data obtainer 1510 may obtain a plurality of images for determining type of content or at least one of a time point and a location for displaying an advertisement, and the pre-processor 1520 may preprocess the plurality of obtained images, such that the plurality of obtained images may be used for determining the type of content or at least one of a time point or a location for displaying an advertisement. Furthermore, the data obtainer 1510 may obtain information regarding a viewing pattern of a user.

The pre-processor 1520 may process the plurality of obtained images into a pre-set format, such that the recognition result provider 1540, as described below, may use the plurality of obtained images for determining the type of content or at least one of a time point or a location for displaying an advertisement. Furthermore, the pre-processor 1520 may preprocess the obtained information regarding the viewing pattern of the user, such that the obtained information regarding the viewing pattern of the user may be used for determining at least one of a time point or a location for displaying an advertisement. The recognizing data selector 1530 may select an image for determining the type of content or at least one of a time point and a location for displaying an advertisement from the preprocessed data. Furthermore, the recognizing data selector 1530 may select information regarding the viewing pattern of the user for determining at least one of a time point and a location for displaying an advertisement from the preprocessed data. Selected data may be provided to the recognition result provider 1540.

The recognition result provider 1540 may apply a selected image to a learning network model according to an example embodiment and determine the type of content or at least one of a time point and a location for displaying an advertisement. The method of determining the type of content or at least one of a time point and a location for displaying an advertisement by inputting a plurality of images to a learning network model may correspond to the method described above with reference to FIGS. 1 through 11. For example, a model for receiving a plurality of images and outputting type of content may be a first learning network model, whereas a model for inputting a plurality of images and outputting at least one of a time point and a location for displaying an advertisement may be a second learning network model. Here, the first learning network model may be generated as a result of learning criteria for determining type of content based on a plurality of images. Furthermore, the second learning network model may be generated as a result of learning criteria for determining at least one of a time point and a location for displaying an advertisement based on a plurality of images and a viewing pattern of a user.

The recognition result provider 1540 may provide type of content or at least one of a time point and a location for displaying an advertisement with respect to a plurality of images.

Based on an evaluation regarding a result of determining a category of an image or reaction information provided by the recognition result provider 1540, the model modifying and refining unit 1540 may provide information regarding the evaluation to the model learner 1440 described above with reference to FIG. 14, such that parameters regarding a network for classifying species or at least one of characteristic extraction layer included in a learning network model may be modified and refined.

At least one of the data obtainer 1510, the pre-processor 1520, the recognizing data selector 1530, the recognition result provider 1540, and the model modifying and refining unit 1550 in the data recognizer 1320 may be fabricated as a hardware chip and mounted on an electronic device. For example, at least one of the data obtainer 1510, the pre-processor 1520, the recognizing data selector 1530, the recognition result provider 1540, and the model modifying and refining unit 1550 may be fabricated as a dedicated hardware chip for AI or may be fabricated as a portion of a conventional general-purpose processor (e.g., a CPU or an application processor) or a graphics processor (e.g., a GPU) and mounted on various electronic devices as described above.

Alternatively, the data obtainer 1510, the pre-processor 1520, the recognizing data selector 1530, the recognition result provider 1540, and the model modifying and refining unit 1550 may be mounted on one electronic device or may be respectively mounted on separate electronic devices. For example, some of the data obtainer 1510, the pre-processor 1520, the recognizing data selector 1530, the recognition result provider 1540, and the model modifying and refining unit 1550 may be included in an electronic device, and the other ones may be included in a server.

Furthermore, at least one of the data obtainer 1510, the pre-processor 1520, the recognizing data selector 1530, the recognition result provider 1540, and the model modifying and refining unit 1550 may be implemented as a software module. When at least one of the data obtainer 1510, the pre-processor 1520, the recognizing data selector 1530, the recognition result provider 1540, and the model modifying and refining unit 1550 is implemented as a software module (or a program module including instructions), the software module may be stored in a non-transitory computer-readable recording medium. Furthermore, in this case, at least one software module may be provided by an OS or by a certain application. Alternatively, some of the at least one software module may be provided by an OS, and the remaining of the at least one software module may be provided by a certain application.

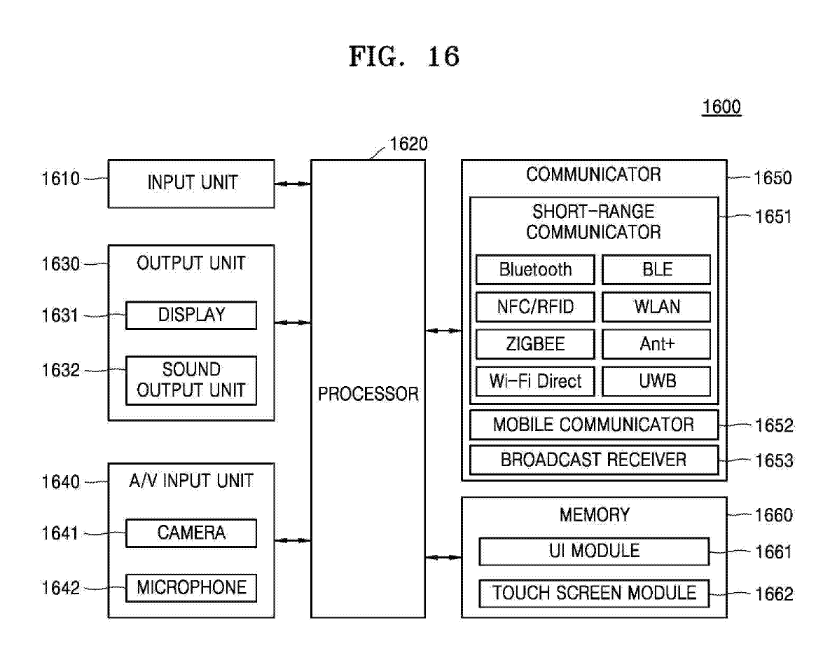

FIG. 16 is a block diagram of an electronic device 1600 that provides an advertisement according to another example embodiment.

Referring to FIG. 16, the electronic device 1600 according to an example embodiment may include a memory 1660, a processor 1620 (including processing circuitry), and an output unit 1630 respectively corresponding to the memory 110, the processor 120, and the output unit 130 of FIG. 12 and may further include an input unit 1610, an A/V input unit 1640, and a communicator 1650.

The input unit 1610 refers to a means by which a user inputs data for controlling the electronic device 1600. For example, the input unit 1610 may include a key pad, a dome switch, a touch pad (a contact capacitance type, a pressure resistive type, an infrared ray detection type, a surface acoustic wave conduction type, an integral tension measuring type, a piezo-effect type, etc.), a jog wheel, and a jog switch, but is not limited thereto.

According to an example embodiment, the input unit 1610 may receive a user input requesting reproduction of content via a touchpad. However, it is merely an embodiment, and the input unit 1610 may also receive a user input requesting reproduction of content from a user through an input device like a remote controller.

The processor 1620 (including processing circuitry) typically controls the overall operation of the electronic device 1600 and signal flows between the internal components of the electronic device 1600 and performs functions for processing data. For example, the processor 1620 may control the overall operations of the input unit 1610, the output unit 1630, the AN input unit 1640, and the communicator 1650 by executing programs (one or more instructions) stored in the memory 1660.

According to an example embodiment, in order to perform the functions of the electronic device 100 described above with reference to FIGS. 1 through 11, the processor 1620 may control the components of the electronic device 1600 to obtain a plurality of a plurality of images included in content, determine a time point for displaying an advertisement reproduced in synchronization with the content based on at least one of the type of the content, image characteristics of each of the plurality of images, and a viewing pattern of a user, and display an advertisement at the determined time point. Since the processor 1620 corresponds to the processor 120 of FIG. 12, detailed description thereof will be omitted.

The output unit 1630 may output a plurality of images included in the content and an advertisement reproduced in synchronization with the content included in the content as video signals at the determined time point, and the sound output unit 1630 may include a display 1631 and a sound output unit 1632.

The display 1631 displays and outputs data processed by the electronic device 1600. When the display 1631 and a touch pad constitutes a layer structure and are configured as a touch screen, the display 1631 may be used as an input device in addition to an output device.

The sound output unit 1632 outputs audio data received from the communicator 1650 or stored in the memory 1660.

The A/V input unit 1640 is for inputting an audio signal or a video signal and may include a camera 1641 and a microphone 1642.

The camera 1641 captures an image within a camera recognition range. An image captured by the camera 1641 according to an example embodiment may be image-processed by the processor 1620 and displayed via the display 1631.

The communicator 1650 (including communications circuitry) may include one or more components for communicating with an external server (e.g., an SNS server, a cloud server, a content-providing server, etc.) and various other external devices. For example, the communicator 1650 may include a short-range communicator 1651, a mobile communicator 1652, and a broadcast receiver 1653.

The short-range communication unit 1651 may include a Bluetooth communicator, a Bluetooth low energy (BLE) communicator, a near field communication unit, a WLAN (Wi-Fi) communicator, a ZigBee communicator, an infrared data association (IrDA) communicator, a WiFi direct (WFD) communicator, an ultra wideband (UWB) communicator, but is not limited thereto.

The mobile communicator 1652 transmits and receives radio signals to and from at least one of a base station, an external terminal, and a server on a mobile communication network. Here, the radio signal may include various types of data for content transmission/reception.

The broadcast receiver 1653 receives a broadcast signal and/or broadcast-related information from the outside through a broadcast channel. The electronic device 1600 may not include the broadcast receiver 1653 according to some embodiments.

According to an example embodiment, the communicator 1650 may receive content from an external server and provide the received content to the processor 1620.

The memory 1660 may store programs (e.g., one or more instructions, a learning network model, etc.) for processing and controlling of the processor 1620 or may store data (e.g., an advertisement) input to or output from the electronic device 1600.

Programs stored in the memory 1660 may be categorized into a plurality of modules according to their functions, e.g., a UI module 1661 and a touch screen module 1662.

The UI module 1661 may provide a specialized UI or a GUI interlocked with the electronic device 1600 for each application. The touch screen module 1662 may sense a touch gesture of a user on a touch screen and may transmit information regarding the touch gesture to the processor 1620. The touch screen module 1662 according to an example embodiment may recognize and analyze a touch code. The touch screen module 1662 may be configured as separate hardware including a controller.

The memory 1660 may include at least one of a flash memory type memory, a hard disk type memory, a multimedia card micro type memory, a card type memory (e.g., SD memory or XD memory), RAM, static random access memory (SRAM), ROM, electrically erasable-programmable read-only memory (EEPROM), programmable read-only memory (PROM), a magnetic memory, a magnetic disk, and an optical disc.

On the other hand, the configuration of the electronic device 1600 shown in FIG. 16 is merely an embodiment, and the components of the electronic device 1600 may be integrated, added, or omitted depending on specifications of an electronic device to be implemented. In other words, as occasions demand, two or more components may be combined into one component or one component may be divided into two or more components. Furthermore, a function performed by each component (or module) is merely for the purpose of describing embodiments, and specific operations or specific devices do not limit the scope of the present disclosure.

What is claimed is:

1. A method of providing an advertisement, the method comprising:
obtaining, by an electronic device, a plurality of images included in content;
determining a time point for displaying an advertisement reproduced in synchronization with the content, based on at least one of a type of the content, image characteristics of the plurality of images, and a viewing pattern of a user for the content; and
displaying the advertisement at the determined time point.

2. The method of claim 1, wherein the determining the time point for displaying the advertisement comprises:
determining the type of the content by using a first learning network model; and
determining at least one of the time point and a location for displaying the advertisement based on at least one of the type of the content, the image characteristics, and the viewing pattern, and
wherein the first learning network model is generated as a result of training criteria for determining the type of the content based on the plurality of images.

3. The method of claim 2, wherein the determining the time point for displaying the advertisement comprises:
determining at least one of the time point and the location for displaying the advertisement by using a second learning network model; and
wherein the second learning network model is generated as a result of training criteria for determining at least one of the time point and the location for displaying the advertisement based on the viewing pattern.

4. The method of claim 1, wherein the determining the time point for displaying the advertisement comprises:
recognizing a plurality of objects included in the content based on the image characteristics;
recognizing sound included in the content; and
determining the time point for displaying the advertisement based on at least the recognized plurality of objects and the recognized sound.

5. The method of claim 1, wherein the determining the time point for displaying the advertisement comprises:
recognizing an object related to the advertisement based on the image characteristics; and
determining an image including the recognized object from among the plurality of images, and
wherein the displaying of the advertisement comprises displaying the advertisement on the determined image.

6. The method of claim 5, wherein the displaying the advertisement comprises:
determining whether the determined image comprises a person; and
when the determined image comprises the person, displaying the advertisement at a location a pre-set distance and/or apart from the person in the determined image.

7. The method of claim 1, wherein the displaying the advertisement comprises changing image quality of an object related to the advertisement.

8. The method of claim 1, wherein the displaying the advertisement comprises displaying a plurality of advertisements corresponding to objects included in content reproduced before the time point for displaying the advertisement at the time point for displaying the advertisement.

9. The method of claim 1, wherein the displaying the advertisement comprises displaying a plurality of advertisements corresponding to a plurality of objects included in the content for each of the plurality of objects.

10. The method of claim 1, wherein the determining the time point for displaying the advertisement comprises determining whether to display the advertisement on the electronic device based on the type of the content and the viewing pattern; and
when the advertisement is not displayed on the electronic device, transmitting the advertisement to a second device of the user.

11. An electronic device for providing an advertisement, the electronic device comprising:
a memory configured to store one or more instructions;
a display; and
a processor configured to execute the one or more instructions stored in the memory to:
determine a time point for displaying an advertisement reproduced in synchronization with content including a plurality of images, based on at least one of a type of the content, image characteristics of the plurality of images, and a viewing pattern of a user for the content, and
display the advertisement at the determined time point.

12. The electronic device of claim 11, wherein, by executing the one or more instructions, the processor is further configured to determine the type of the content via a first learning network model,
wherein at least one of the time point and a location for displaying the advertisement is determined based on at least one of the determined type of the content, the image characteristics, and the viewing pattern, and
wherein the first learning network model is generated as a result of learning criteria for determining the type of the content based on the plurality of images.

13. The electronic device of claim 11, wherein, by executing the one or more instructions, the processor is further configured to determine at least one of the time point and the location for displaying the advertisement via a second learning network model generated as a result of learning criteria for determining at least one of the time point and the location for displaying the advertisement based on the plurality of images and the viewing pattern.

14. The electronic device of claim 11, wherein, by executing the one or more instructions, the processor is further configured to recognize a plurality of objects included in the content based on the image characteristics, recognize sound included in the content, and determine the time point for displaying the advertisement based at least on the plurality of recognized objects and the recognized sound.

15. The electronic device of claim 11, wherein, by executing the one or more instructions, the processor is further configured to recognize an object related to the advertisement based on the image characteristics, determine an image including the recognized object from among the plurality of images, and display the advertisement on the determined image.

16. The electronic device of claim 15, wherein, by executing the one or more instructions, the processor is further configured to determine whether the determined image comprises a person and, when the determined image comprises the person, display the advertisement at a location a pre-set distance and/or apart from the person.

17. The electronic device of claim 11, wherein, by executing the one or more instructions, the processor is further configured to change image quality of an object related to the advertisement.

18. The electronic device of claim 11, wherein, by executing the one or more instructions, the processor is further configured to display a plurality of advertisements corresponding to objects included in content reproduced before the time point for displaying the advertisement at the time point for displaying the advertisement.

19. The electronic device of claim 11, wherein, by executing the one or more instructions, the processor is further configured to display a plurality of advertisements corresponding to a plurality of objects included in the content for each of the plurality of objects.

20. The electronic device of claim 11, wherein, by executing the one or more instructions, the processor is further configured to determine whether to display the advertisement on the electronic device based on at least the type of the content and the viewing pattern and, when the advertisement is not displayed on the electronic device, transmit the advertisement to a second device of the user.

21. A non-transitory computer-readable recording medium having recorded thereon a program for implementing the method of claim 1.
